(19) United States
(12) Patent Application Publication
(10) Pub. No.: US 2026/0267434 A1
(43) Pub. Date: Sep. 10, 2026

(54) TOUCH STRUCTURE, DISPLAY SUBSTRATE, AND DISPLAY DEVICE

(71) Applicants: CHENGDU BOE OPTOELECTRONICS TECHNOLOGY CO., LTD., Chengdu (CN); BOE TECHNOLOGY GROUP CO., LTD., Beijing (CN)

(72) Inventors: Wei Wang, Beijing (CN); Peng Xu, Beijing (CN); Huijuan Yang, Beijing (CN); Yi Zhang, Beijing (CN); Chunyan Li, Beijing (CN)

(21) Appl. No.: 18/842,790

(22) PCT Filed: Nov. 28, 2023
(86) PCT No.: PCT/CN2023/134642

§ 371 Date: Aug. 29, 2024

(51) Int. Cl. G06F 3/041; G06F 3/044

(52) U.S. Cl. CPC G06F 3/04164; G06F 3/0446; G06F 2203/04111

(57) ABSTRACT

A touch structure is provided, including: first and second touch regions; first and second touch wiring regions; multiple first touch electrode strips; and first and second touch wiring groups in first and second touch wiring regions respectively. The first touch wiring group includes the m^{th} first touch wiring closest to the second touch wiring group. The second touch wiring group includes the n^{th} second touch wiring closest to the first touch wiring group. One of the m^{th} first touch wiring and the n^{th} second touch wiring includes a compensation wiring portion, such that a part of the m^{th} first touch wiring and the compensation wiring portion are in parallel or a part of the n^{th} second touch wiring and the compensation wiring portion are in parallel, thereby generating a compensation capacitance between the m^{th} first touch wiring and the n^{th} second touch wiring

### TECHNICAL FIELD

The present disclosure relates to a field of display technology, in particular to a touch structure, a display substrate, and a display device.

### BACKGROUND

With the continuous development of display technology, user interfaces with touch functions are widely used in various electronic devices, such as a display panel or a display device. A touch structure used to implement touch functions includes a touch electrode and a touch wiring. A method of providing the touch wiring is one of important factors affecting the touch sensitivity.

The above information disclosed in this section is only used for understanding the background of the inventive concept of the present disclosure. Therefore, the above information may contain information that does not constitute the prior art.

### SUMMARY

In an aspect, a touch structure is provided, including a first touch region, a second touch region, a first touch wiring region, and a second touch wiring region, where the second touch region is on a side of the first touch region in a first direction, the second touch wiring region is on a side of the first touch wiring region in the first direction, and the touch structure further includes:
a plurality of first touch electrode strips extending in a second direction and spaced apart from each other in the first direction, where one or more of the plurality of first touch electrode strips are in the first touch region, rest of the plurality of first touch electrode strips are in the second touch region, and the first direction intersects with the second direction; and
a plurality of touch wirings, including a first touch wiring group in the first touch wiring region and a second touch wiring group in the second touch wiring region, where the first touch wiring group includes m first touch wirings, the first touch wiring is electrically connected to the first touch electrode strip in the first touch region, and adjacent two first touch wirings are in parallel; the second touch wiring group includes n second touch wirings, the second touch wiring is electrically connected to the first touch electrode strip in the second touch region, adjacent two second touch wirings are in parallel; and each of m and n is an integer greater than or equal to 2,
where the first touch wiring group includes a m^{th} first touch wiring closest to the second touch wiring group, the second touch wiring group includes a n^{th} second touch wiring closest to the first touch wiring group, and one of the m^{th} first touch wiring and the n^{th} second touch wiring includes a compensation wiring portion, such that a part of the m^{th} first touch wiring is parallel to the compensation wiring portion in the n^{th} second touch wiring or a part of the n^{th} second touch wiring is parallel to the compensation wiring portion in the m^{th} first touch wiring, so as to generate a compensation capacitance between the m^{th} first touch wiring and the n^{th} second touch wiring.

According to some exemplary embodiments, the m^{th} first touch wiring includes the compensation wiring portion, the compensation wiring portion extends from the first touch wiring region to the second touch wiring region, the compensation wiring portion is parallel to the part of the n^{th} second touch wiring, the second touch wiring group includes a (n-1)^{th} second touch wiring adjacent to the n^{th} second touch wiring, and the compensation wiring portion is on a side of the n^{th} second touch wiring away from the (n-1)^{th} second touch wiring; or

the n^{th} second touch wiring includes the compensation wiring portion, the compensation wiring portion extends from the second touch wiring region to the first touch wiring region, the compensation wiring portion is parallel to the part of the m^{th} first touch wiring, the first touch wiring group includes a (m-1)^{th} first touch wiring adjacent to the m^{th} first touch wiring, and the compensation wiring portion is on a side of the m^{th} first touch wiring away from the (m-1)^{th} first touch wiring.

According to some exemplary embodiments, a compensation capacitance generated between the compensation wiring portion and the n^{th} second touch wiring is substantially equal to a parasitic capacitance generated between the n^{th} second touch wiring and the (n-1)^{th} second touch wiring; or

a compensation capacitance generated between the compensation wiring portion and the m^{th} first touch wiring is substantially equal to a parasitic capacitance generated between the m^{th} first touch wiring and the (m-1)^{th} first touch wiring.

According to some exemplary embodiments, a spacing between the compensation wiring portion and the n^{th} second touch wiring is equal to a spacing between the n^{th} second touch wiring and the (n-1)^{th} second touch wiring, and a parallel distance between the compensation wiring portion and the n^{th} second touch wiring is equal to a parallel distance between the n^{th} second touch wiring and the (n-1)^{th} second touch wiring; or

a spacing between the compensation wiring portion and the m^{th} first touch wiring is equal to a spacing between the m^{th} first touch wiring and the (m-1)^{th} first touch wiring, and a parallel distance between the compensation wiring portion and the m^{th} first touch wiring is equal to a parallel distance between the m^{th} first touch wiring and the (m-1)^{th} first touch wiring.

According to some exemplary embodiments, a spacing between the compensation wiring portion and the n^{th} second touch wiring is less than a spacing between the n^{th} second touch wiring and the (n-1)^{th} second touch wiring, and a parallel distance between the compensation wiring portion and the n^{th} second touch wiring is less than a parallel distance between the n^{th} second touch wiring and the (n-1)^{th} second touch wiring; or

a spacing between the compensation wiring portion and the m^{th} first touch wiring is less than a spacing between the m^{th} first touch wiring and the (m-1)^{th} first touch wiring, and a parallel distance between the compensation wiring portion and the m^{th} first touch wiring is less than a parallel distance between the m^{th} first touch wiring and the (m-1)^{th} first touch wiring.

According to some exemplary embodiments, the touch structure further includes a plurality of touch driving electrodes and a plurality of touch sensing electrodes, one first touch electrode strip includes the plurality of touch driving electrodes arranged sequentially in the second direction and electrically connected to each other, or one first touch electrode strip includes the plurality of touch sensing electrodes arranged sequentially in the second direction and electrically connected to each other.

According to some exemplary embodiments, the compensation wiring portion is in a same layer as the first touch wiring group and the second touch wiring group.

In another aspect, a display substrate is provided, where the display substrate includes a display region and a peripheral region at a periphery of the display region, and the display substrate further includes:
a base substrate;
a light-emitting layer on the base substrate;
an encapsulation layer on a side of the light-emitting layer away from the base substrate; and
a touch structure on a side of the encapsulation layer away from the base substrate, where the touch structure includes the above-mentioned touch structure.

According to some exemplary embodiments, the display substrate further includes a dam on the base substrate and in the peripheral region, where the dam includes a first dam surrounding the display region and a second dam surrounding the first dam, and at least one of the touch wirings extends from a side of the second dam close to the display region to a side of the second dam away from the display region.

According to some exemplary embodiments, the display substrate further includes a bridging wiring portion on a side of the second dam close to the base substrate or on a side of a part of the second dam close to the base substrate, where at least one of the touch wirings includes an inner touch wiring portion on the side of the second dam close to the display region and an outer touch wiring portion on the side of the second dam away from the display region, one end of the bridging wiring portion is electrically connected to the inner touch wiring portion, and the other end of the bridging wiring portion is electrically connected to the outer touch wiring portion.

According to some exemplary embodiments, the display substrate further includes a source drain metal layer on the base substrate; and a touch metal layer on a side of the source drain metal layer away from the base substrate, where the bridging wiring portion is in the source drain metal layer, and the inner touch wiring portion and the outer touch wiring portion are in the touch metal layer.

According to some exemplary embodiments, the display substrate further includes a raised portion adjacent to the second dam, where the raised portion includes a first raised portion on the side of the second dam close to the display region and a second raised portion on a side of the second dam away from the first raised portion, and at least one of the touch wirings crosses the second dam via the first raised portion and extends to the second raised portion.

According to some exemplary embodiments, the touch wiring is in a touch metal layer, the display substrate further includes a planarization layer on a side of the touch metal layer close to the base substrate, and the raised portion is in the planarization layer.

According to some exemplary embodiments, the display substrate further includes an organic insulating layer on a side of the plurality of touch wirings close to the base substrate, where the plurality of touch wirings further include a first wiring portion crossing a boundary of the organic insulating layer and a second wiring portion on both sides of the first wiring portion, a spacing between adjacent two touch wirings in the first wiring portion is a first spacing, a spacing between adjacent two touch wirings in the second wiring portion is a second spacing, and the first spacing is greater than the second spacing.

According to some exemplary embodiments, the first spacing is greater than or equal to 8 microns.

According to some exemplary embodiments, the display substrate further includes: a first planarization layer on the base substrate; a second planarization layer on a side of the first planarization layer away from the base substrate; and a third planarization layer on a side of the second planarization layer away from the base substrate;

where the organic insulating layer includes at least one of the first planarization layer, the second planarization layer, and the third planarization layer.

According to some exemplary embodiments, the display substrate further includes a first electrode layer on a side of the light-emitting layer close to the base substrate, the peripheral region includes a corner region outside a corner of the display region, the display substrate further includes a second electrode power signal bridging portion in the first electrode layer, and the second electrode power signal bridging portion includes a first exhaust hole;

where a part of the second electrode power signal bridging portion is in the corner region, and a part of the touch wiring is in the corner region; and

where in the corner region, an orthographic projection of the touch wiring on the base substrate does not overlap with an orthographic projection of the first exhaust hole on the base substrate.

According to some exemplary embodiments, the display substrate further includes a source drain metal layer on a side of the first electrode layer close to the base substrate, and a second electrode signal wiring in the source drain metal layer;

where a part of the second electrode signal wiring is in the corner region, and the second electrode signal wiring includes a second exhaust hole; and

where in the corner region, the orthographic projection of the first exhaust hole on the base substrate at least partially overlaps with an orthographic projection of the second exhaust hole on the base substrate, and in the corner region, the orthographic projection of the touch wiring on the base substrate is spaced apart from the orthographic projection of one of the first exhaust hole and the second exhaust hole on the base substrate.

According to some exemplary embodiments, the display substrate further includes a source drain metal layer on a side of the first electrode layer close to the base substrate, and a second electrode signal wiring in the source drain metal layer;

where an orthographic projection of the second electrode signal wiring on the base substrate is spaced apart from the orthographic projection of the first exhaust hole in the corner region on the base substrate.

According to some exemplary embodiments, the peripheral region further includes a first side region on a side of the display region in the second direction; and in the first side region, the orthographic projection of the first exhaust hole on the base substrate is spaced apart from the orthographic projection of the second exhaust hole on the base substrate; and

in the first side region, the orthographic projection of the touch wiring on the base substrate at least partially overlaps with the orthographic projection of the first exhaust hole on the base substrate; and/or, the orthographic projection of the touch wiring on the base substrate at least partially overlaps with the orthographic projection of the second exhaust hole on the base substrate.

In another aspect, a display device is provided, including the above-mentioned display substrate.

### BRIEF DESCRIPTION OF THE DRAWINGS

The features and advantages of the present disclosure will become more apparent through the detailed description of exemplary embodiments of the present disclosure with reference to the accompanying drawings.

FIG. 1 shows a schematic diagram of a structure of touch electrode strips extending longitudinally and touch wirings in the related art.

FIG. 2 schematically shows a schematic plan view of a touch structure according to an embodiment of the present disclosure.

FIG. 3 schematically shows an enlarged schematic diagram of a structure in a region Q in FIG. 2.

FIG. 4 schematically shows another enlarged schematic diagram of a structure in a region Q in FIG. 2.

FIG. 5 schematically shows a schematic cross-sectional view of a touch structure according to an embodiment of the present disclosure.

FIG. 6 schematically shows a schematic plan view of a display substrate according to an embodiment of the present disclosure.

FIG. 7 schematically shows a schematic cross-sectional view of a display substrate according to an embodiment of the present disclosure.

FIG. 8 schematically shows a schematic plan view of a dam in a display substrate according to an embodiment of the present disclosure.

FIG. 9 schematically shows a schematic cross-sectional view at position B-B′ in FIG. 8.

FIG. 10 schematically shows another schematic cross-sectional view at position B-B′ in FIG. 8.

FIG. 11 schematically shows another schematic cross-sectional view at position B-B′ in FIG. 8.

FIG. 12 schematically shows a schematic plan view of a touch wiring at a boundary of an organic insulating layer in a display substrate according to an embodiment of the present disclosure.

FIG. 13 schematically shows a schematic plan view of a touch wiring in a corner region of a display substrate according to an embodiment of the present disclosure.

FIG. 14A schematically shows a schematic plan view of a touch wiring in a corner region of a display substrate according to an embodiment of the present disclosure.

FIG. 14B schematically shows a schematic cross-sectional view at position BB′ in FIG. 14A.

FIG. 15 schematically shows a schematic plan view of a touch wiring in a first side region of a display substrate according to an embodiment of the present disclosure.

### DETAILED DESCRIPTION OF EMBODIMENTS

In order to make the objectives, technical solutions and advantages of embodiments of the present disclosure more apparent, the technical solutions of the embodiments of the present disclosure will be described clearly and completely with reference to the accompanying drawings. It is obvious that the embodiments described are only some of the embodiments of the present disclosure, rather than all the embodiments. All other embodiments, which are derived by those of ordinary skill in the art from the embodiments of the present disclosure without carrying out inventive effort, fall within the protection scope of the present disclosure.

It should be noted that in the accompanying drawings, sizes and relative sizes of elements may be enlarged for clarity and/or description. As such, the sizes and relative sizes of various elements are not necessarily limited to those shown in the figures. In the description and the drawings, the same or similar reference numerals denote the same or similar components.

When an element is described as being “on”, “connected to” or “coupled to” a further element, the element may be directly on, directly connected to or directly coupled to the further element, or an intervening element may be present. However, when an element is described as being “directly on”, “directly connected to” or “directly coupled to” a further element, there is no intervening element. Other terms and/or expressions used to describe a relationship between elements should be interpreted in a similar manner, such as, “between . . . and . . . ” versus “directly between . . . and . . . ” “adjacent” versus “directly adjacent”, or “on” versus “directly on”, etc. Moreover, a term “connection” may refer to a physical connection, an electrical connection, a communication connection, and/or a fluid connection. Furthermore, X, Y, and Z axes are not limited to three axes of a rectangular coordinate system, and may be interpreted in a broader sense. For example, the X, Y, and Z axes may be perpendicular to each other, or may represent different directions that are not perpendicular to each other. For the present disclosure, “at least one of X, Y, or Z” and “at least one selected from a group consisting of X, Y, and Z” may be interpreted as X only, Y only, Z only, or any combination of two or more of X, Y and Z, such as XYZ, XYY, YZ and ZZ. As used herein, a term “and/or” includes any and all combinations of one or more of related items listed.

It should be noted that, although the terms “first”, “second”, etc. may be used herein to describe various components, members, elements, regions, layers and/or portions, these components, members, elements, regions, layers and/or portions should not be limited by these terms. Rather, these terms are used to distinguish one component, member, element, region, layer and/or portion from another. Therefore, for example, a first component, a first member, a first element, a first region, a first layer, and/or a first portion discussed below may be termed a second component, a second member, a second element, a second region, a second layer, and/or a second portion without departing from teachings of the present disclosure.

For ease of description, spatial relationship terms, such as “upper”, “lower”, “left”, “right”, and the like, may be used in the present disclosure to describe a relationship between one element or feature and another element or feature as illustrated in the figures. It should be understood that the spatial relationship terms are intended to encompass other different orientations of a device in use or operation in addition to an orientation depicted in the figures. For example, if the device in the figures is turned over, an element described as “below” or “beneath” a further element or feature would then be oriented as the element “above” or “over” the further element or feature.

In the present disclosure, the terms “substantially”, “about”, “approximately”, “roughly”, and other similar terms are used as terms of approximation rather than as terms of degree, and are intended to account for inherent deviations in measured or calculated values that would be recognized by those of ordinary skill in the art. Taking into account factors such as process fluctuations, measurement problems, errors associated with measurement of particular quantities (i.e., limitations of a measurement system), etc., “about” or “approximately” as used in the present disclosure includes the stated values, and indicates that the particular values determined by those of ordinary skill in the art are within acceptable tolerances. For example, “about” may mean within one or more standard deviations, or within ±30%, ±20%, ±10% or ±5% of the stated values.

It should be noted that in the present disclosure, the term “same layer” refers to a layer structure formed by using the same film-forming process to form a film layer with a specific pattern followed by patterning the film layer using the same mask through a single patterning process. According to different specific patterns, a single patterning process may include multiple exposures, developments, or etching processes, and the specific pattern in the formed layer structure may be continuous or discontinuous. That is, a plurality of elements, components, structures, and/or portions in the “same layer” are composed of the same material and formed through the same patterning process. Typically, the plurality of elements, components, structures, and/or portions in the “same layer” have substantially the same thickness.

Those skilled in the art should understand that in the present disclosure, unless otherwise specified, the expression “height” or “thickness” refers to a size of a surface of each film layer provided in a direction perpendicular to a display substrate, that is, a size in a light output direction of the display substrate, or a size in a normal direction of the display device.

At present, touch screens are gradually spread throughout people's lives. According to the composition structure, touch screens may be divided into Add on Mode, On Cell, In Cell, and the like. According to the working principle, touch screens may be divided into a capacitive type, a resistive type, an infrared type, a surface acoustic wave type, and the like. The touch screen with the capacitive On Cell type is a touch structure formed on a surface on a light output side of a display screen. Due to its advantages of simple structure, thin thickness, and high transmittance, the touch screen with the capacitive On Cell type has gradually become a mainstream technology.

Capacitive touch technology mainly includes self-capacitive touch technology and mutual-capacitive touch technology. Taking the mutual-capacitive touch technology as an example, a mutual-capacitive touch structure includes a plurality of touch electrodes. The plurality of touch electrodes include touch driving electrode strips and touch sensing electrode strips extending in different directions. The touch driving electrode strip and the touch sensing electrode strip form mutual capacitance for touch sensing at an intersection of the touch driving electrode strip and the touch sensing electrode strip. The touch driving electrode strip is used to input an excitation signal (such as a touch driving signal), and the touch sensing electrode strip is used to output a touch sensing signal. For example, by inputting the excitation signal to the longitudinally extending touch driving electrode and receiving the touch sensing signal from the laterally extending touch sensing electrode, or by inputting the excitation signal to the laterally extending touch driving electrode and receiving the touch sensing signal from the longitudinally extending touch sensing electrode, a detection signal reflecting a capacitance value of a coupling point (such as an intersection point) of the horizontal and vertical electrodes may be obtained. When a finger touches a touch screen (such as a cover glass), the coupling between the touch driving electrode strip and the touch sensing electrode strip near a touch point is affected, thereby changing the capacitance of the mutual capacitance formed by these two electrode strips at the intersection point, resulting in a change in the output touch sensing signal. A corresponding coordinate of the touch point may be calculated according to the data change of the touch sensing signal.

The touch driving signal is input to the touch driving electrode strip through the touch driving wiring, and the touch sensing signal collected by the touch sensing electrode strip is transmitted to the touch sensing wiring. One end or both ends of the touch driving electrode strip may be connected to the touch driving wiring. One end or both ends of the touch sensing electrode strip may be connected to the touch sensing wiring. According to the connection method of the wiring, the wiring modes of the touch wiring are divided into 1T1R, 2T1R, 1T2R, and 2T2R. 1T1R refers to that one end of the touch driving electrode strip is connected to the touch driving wiring, and one end of the touch sensing electrode strip is connected to the touch sensing wiring. 2T1R refers to that both ends of the touch driving electrode strip are connected to the touch driving wiring, and one end of the touch sensing electrode strip is connected to the touch sensing wiring. 1T2R refers to that one end of the touch driving electrode strip is connected to the touch driving wiring, and both ends of the touch sensing electrode strip are connected to the touch sensing wiring. 2T2R refers to that both ends of the touch driving electrode strip are connected to the touch driving wiring, and both ends of the touch sensing electrode strip are connected to the touch sensing wiring.

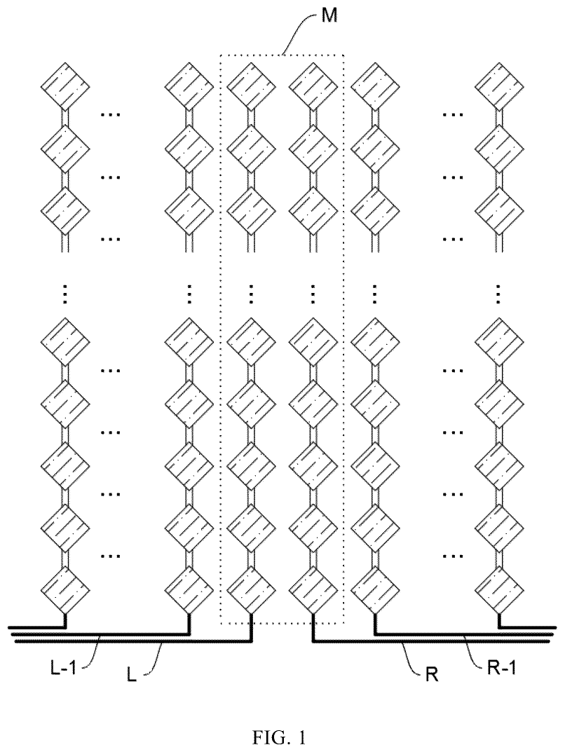

FIG. 1 shows a schematic diagram of a structure of touch electrode strips extending longitudinally and touch wirings in the related art.

With reference to FIG. 1, when the touch wiring is connected to one end of the longitudinally extending touch electrode strip, there is a problem of low touch sensitivity in a middle region M. The inventors find in the research that in this type of touch wiring, some of the touch wirings on the left side extend to the left side after being led out, while the other of the touch wirings on the right side extend to the right side after being led out; since adjacent two touch wirings are usually in parallel and a line spacing between the adjacent two touch wirings is small, parasitic capacitance is inevitably generated between the adjacent two touch wirings when an electrical signal is applied to the touch wirings.

With reference to FIG. 1, it should be understood that a part of a touch wiring L-1 is parallel to a part of a touch wiring L, so that parasitic capacitance is generated between the touch wiring L-1 and the touch wiring L. A part of a touch wiring R-1 is parallel to a part of a touch wiring R, so that parasitic capacitance is generated between the touch wiring R-1 and the touch wiring R. However, since the touch wiring L and the touch wiring R extend in opposite directions and the touch wiring L is not parallel to the touch wiring R, there is almost no parasitic capacitance generated between the touch wiring L and the touch wiring R. Therefore, there will be a phenomenon of parasitic capacitance jump from the touch wiring L to the touch wiring R, which leads to the problem that the touch sensitivity decreases in the region where the touch electrode strips electrically connected to the touch wiring L and the touch wiring R respectively are located. That is, there is a problem of low touch sensitivity in the middle region M.

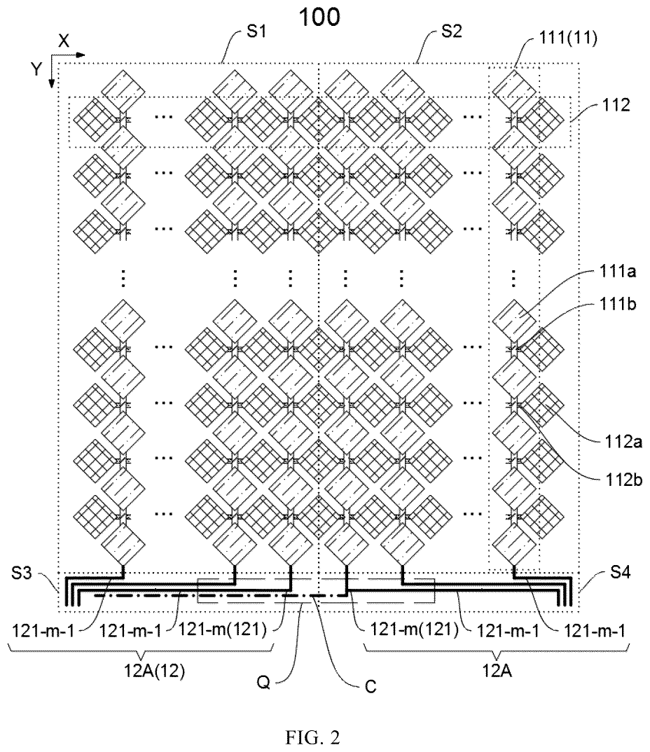

FIG. 2 schematically shows a schematic plan view of a touch structure according to an embodiment of the present disclosure.

With reference to FIG. 2, a touch structure 100 includes a first touch region S1, a second touch region S2, a first touch wiring region S3, and a second touch wiring region S4. The second touch region S2 is on a side of the first touch region S1 in a first direction X. The second touch wiring region S4 is on a side of the first touch wiring region S3 in the first direction X. The first touch wiring region S3 is on a side of the first touch region S1 in a second direction Y. The second touch wiring region S4 is on a side of the second touch region S2 in the second direction Y. The first direction X intersects with the second direction Y, for example, the first direction X is perpendicular to the second direction Y.

The touch structure 100 includes a plurality of touch electrode strips 11 and a plurality of touch wirings 12. One touch wiring 12 is electrically connected to one corresponding touch electrode strip 11.

The plurality of touch electrode strips 11 include a plurality of first touch electrode strips 111 and a plurality of second touch electrode strips 112. The plurality of first touch electrode strips 111 extend in the second direction Y and are spaced apart from each other in the first direction X. The plurality of second touch electrode strips 112 extend in the first direction X and are spaced apart from each other in the second direction Y. The plurality of first touch electrode strips 111 intersect with the plurality of second touch electrode strips 112, and the plurality of first touch electrode strips 111 are insulated from the plurality of second touch electrode strips 112. One or more of the plurality of first touch electrode strips 111 are in the first touch region S1, and rest of the plurality of first touch electrode strips 111 are in the second touch region S2.

The plurality of touch wirings 12 include a first touch wiring group 12A and a second touch wiring group 12B. The first touch wiring group 12A is in the first touch wiring region S3. The first touch wiring group 12A includes m first touch wirings 121. One first touch wiring m is electrically connected to one end of one first touch electrode strip 111 in the first touch region S1 close to the first touch wiring region S3. Adjacent two first touch wirings 121 are in parallel. The second touch wiring group 12B is in the second touch wiring region S4. The second touch wiring group 12B includes n second touch wirings 122. One second touch wiring 122 is connected to one end of the first touch electrode strip 111 in the second touch region S2 close to the second touch wiring region S4. Adjacent two second touch wirings 122 are in parallel.

The plurality of touch wirings 12 further include a plurality of third touch wirings, which are not specifically illustrated in FIG. 2. One end of one second touch electrode strip 112 is electrically connected to one third touch wiring, or both ends of one second touch electrode strip 112 are respectively electrically connected to one third touch wiring.

In a direction pointing from the first touch wiring region S3 to the second touch wiring region S4, the first touch wiring group 12A is sequentially provided with a 1^{st} first touch wiring 121-1, . . . , a (m-1)^{th} first touch wiring 121-m-1 and a m^{th} first touch wiring 121-m. In a direction pointing from the second touch wiring region S4 to the first touch wiring region S3, the second touch wiring group 12B is sequentially provided with a 1^{st} second touch wiring 122-1, . . . , a (n-1)^{th} second touch wiring 122-n-1 and a n^{th}second touch wiring 122-n.

That is, the first touch wiring group 12A includes the m^{th} first touch wiring 121-m closest to the second touch wiring group 12B; and the second touch wiring group 12B includes the n^{th} second touch wiring 122-n closest to the first touch wiring group 12A. One of the m^{th} first touch wiring 121-m and the n^{th} second touch wiring 122-n includes a compensation wiring portion C, such that a part of the m^{th} first touch wiring 121-m is parallel to the compensation wiring portion C in the n^{th} second touch wiring 122-n, or such that a part of the n^{th} second touch wiring 122-n is parallel to the compensation wiring portion C in the m^{th} first touch wiring 121-m, thereby generating a compensation capacitance between the m^{th} first touch wiring 121-m and the n^{th} second touch wiring 122-n. In this way, a capacitance value of a parasitic capacitance of adjacent touch wirings is avoided from generating an obvious jump between the m^{th} first touch wiring 121-m and the n^{th} second touch wiring 122-n, so as to avoid the problem that the touch sensitivity decreases in the region where the first touch electrode strips 111 electrically connected to the m^{th} first touch wiring 121-m and the n^{th} second touch wiring 122-n respectively are located.

For example, the first touch wirings 121 converge in a region in the first touch wiring region S3 away from the second touch wiring region S4, and the second touch wirings 122 converge in a region in the second touch wiring region S4 away from the first touch wiring region S3. The first touch wirings 121 and the second touch wirings 122 are connected to a binding region after converging in the first touch wiring region S3 and the second touch wiring region S4, respectively. The binding region includes a touch driving chip. The first touch wirings 121 and the second touch wirings 122 are connected to the touch driving chip in the binding region. For example, the touch driving chip includes a plurality of pins, and each pin may correspond to a contact pad. The first touch wirings 121 and the second touch wirings 122 are connected to the touch driving chip through the contact pads.

For example, the first touch electrode strip 111 includes a plurality of first touch electrode portions 111a spaced apart from each other in the second direction Y, and adjacent two first touch electrode portions 111a are electrically connected through a first connection portion 111b. The second touch electrode strip 112 includes a plurality of second touch electrode portions 112a spaced apart from each other in the first direction X, and adjacent two first touch electrode portions 111a are electrically connected through a first connection portion 112b.

For example, the outer contour of each of the first touch electrode portion 111a and the second touch electrode portion 111a is substantially in a diamond shape. In other examples, the outer contours of each of the first touch electrode portion 111a and the second touch electrode portion 111a may also be in other shapes, such as a triangle shape, a strip shape, and the like.

For example, m is an integer greater than or equal to 2, and n is an integer greater than or equal to 2. For another example, each of m and n is a positive integer greater than or equal to 3, 4, or 5.

In some embodiments of the present disclosure, m may be equal to n, i.e., the number of touch wirings 12 included in the first touch wiring group 12A may be equal to the number of touch wirings 12 included in the second touch wiring group 12B. In other embodiments of the present disclosure, m may not be equal to n, i.e., the number of touch wirings 12 included in the first touch wiring group 12A may be different from the number of touch wirings 12 included in the second touch wiring group 12B.

In some embodiments of the present disclosure, the number m of first touch wirings 121 is equal to the number of first touch electrode strips 111 in the first touch region S1, and the number n of second touch wirings 122 is equal to the number of first touch electrode strips 111 in the second touch region S2.

For example, a plurality of first touch electrode strips 111 and a plurality of second touch electrode strips 112 are provided. In order to simplify the drawings, FIG. 2 schematically shows some of the first touch electrode strips 111 and some of the second touch electrode strips 112.

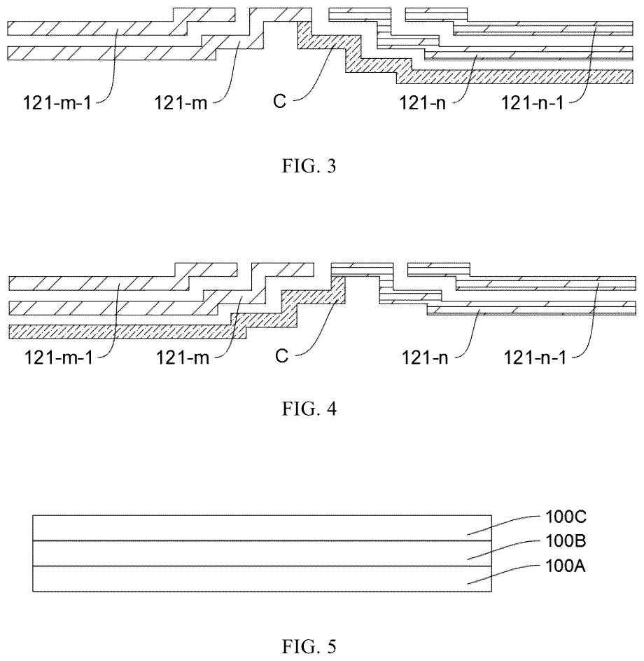

FIG. 3 schematically shows an enlarged schematic diagram of a structure in a region Q in FIG. 2.

In the embodiments of the present disclosure, with reference to FIG. 2 and FIG. 3, the m^{th} first touch wiring 121-m includes a compensation wiring portion C. The compensation wiring portion C extends from the first touch wiring region S3 to the second touch wiring region S4. The compensation wiring portion C is parallel to a part of the n^{th} second touch wiring 122-n. The second touch wiring group includes the (n-1)^{th} second touch wiring 122-n-1 adjacent to the n^{th} second touch wiring 122-n. The compensation wiring portion C is on a side of the n^{th} second touch wiring 122-n away from the (n-1)^{th} second touch wiring 122-n-1.

In the embodiments of the present disclosure, since a capacitance value between adjacent two wirings is directly proportional to a parallel distance and inversely proportional to a wiring spacing, the compensation wiring portion C may be provided such that the compensation capacitance generated between the compensation wiring portion C and the n^{th} second touch wiring 122-n may be substantially equal to the parasitic capacitance generated between the n^{th} second touch wiring 122-n and the (n-1)^{th} second touch wiring 122-n-1.

In the embodiments of the present disclosure, a spacing between the compensation wiring portion C and the n^{th} second touch wiring 122-n is equal to a spacing between the n^{th} second touch wiring 122-n and the (n-1)^{th} second touch wiring 122-n-1, and a parallel distance between the compensation wiring portion C and the n^{th} second touch wiring 122-n is equal to a parallel distance between the n^{th} second touch wiring 122-n and the (n-1)^{th} second touch wiring 122-n-1, such that the compensation capacitance generated between the compensation wiring portion C and the n^{th} second touch wiring 122-n is substantially equal to the parasitic capacitance generated between the n^{th} second touch wiring 122-n and the (n-1)^{th} second touch wiring 122-n-1.

In the actual manufacturing process, due to the accuracy of the manufacturing process and other reasons, it is difficult to ensure that the spacing between the compensation wiring portion C and the n^{th} second touch wiring 122-n is completely equal to the spacing between the n^{th} second touch wiring 122-n and the (n-1)^{th} second touch wiring 122-n-1, and it is also difficult to ensure that the parallel distance between the compensation wiring portion C and the n^{th} second touch wiring 122-n is completely equal to the parallel distance between the n^{th} second touch wiring 122-n and the (n-1)th second touch wiring 122-n-1. The term “equal” used here refers to the value within the acceptable deviation range determined by those ordinary skilled in the art. For example, the spacing between compensation wiring portion C and the n^{th} second touch wiring 122-n is within the range of ±5% of the spacing between the n^{th} second touch wiring 122-n and the (n-1)^{th} second touch wiring 122-n-1, and the parallel distance between the compensation wiring portion C and the n^{th} second touch wiring 122-n is within the range of ±5% of the parallel distance between the n^{th} second touch wiring 122-n and the (n-1)^{th} second touch wiring 122-n-1.

In the embodiments of the present disclosure, the spacing between the compensation wiring portion C and the n^{th} second touch wiring 122-n is less than the spacing between the n^{th} second touch wiring 122-n and the (n-1)^{th} second touch wiring 122-n-1, and the parallel distance between the compensation wiring portion C and the n^{th} second touch wiring 122-n is less than the parallel distance between the n^{th} second touch wiring 122-n and the (n-1)^{th} second touch wiring 122-n-1, such that the compensation capacitance generated between the compensation wiring portion C and the n^{th} second touch wiring 122-n is substantially equal to the parasitic capacitance generated between the n^{th} second touch wiring 122-n and the (n-1)^{th} second touch wiring 122-n-1. In this way, the area occupied by the compensation wiring portion C may be reduced.

FIG. 4 schematically shows another enlarged schematic diagram of a structure in a region Q in FIG. 2.

In the embodiments of the present disclosure, with reference to FIG. 2 and FIG. 4, the n^{th} second touch wiring 122-n includes a compensation wiring portion C. The compensation wiring portion C extends from the second touch wiring region to the first touch wiring region. The compensation wiring portion C is parallel to a part of the m^{th} first touch wiring 121-m. The first touch wiring group includes the (m-1)^{th} first touch wiring 121-m-1 adjacent to the m^{th} first touch wiring 121-m. The compensation wiring portion C is on a side of the m^{th} first touch wiring 121-m away from the (m-1)^{th} first touch wiring 121-m-1.

In the embodiments of the present disclosure, since a capacitance value between adjacent two wirings is directly proportional to a parallel distance and inversely proportional to a wiring spacing, the compensation wiring portion C may be provided such that the compensation capacitance generated between the compensation wiring portion C and the m^{th} first touch wiring 121-m is substantially equal to the parasitic capacitance generated between the m^{th} first touch wiring 121-m and the (m-1)^{th} first touch wiring 121-m-1.

In the embodiments of the present disclosure, a spacing between the compensation wiring portion C and the m^{th} first touch wiring 121-m is equal to a spacing between the m^{th} first touch wiring 121-m and the (m-1)^{th} first touch wiring 121-m-1, and a parallel distance between the compensation wiring portion C and the m^{th} first touch wiring 121-m is equal to a parallel distance between the m^{th} first touch wiring 121-m and the (m-1)^{th} first touch wiring 121-m-1, such that the compensation capacitance generated between the compensation wiring portion C and the m^{th} first touch wiring 121-m is substantially equal to the parasitic capacitance generated between the m^{th} first touch wiring 121-m and the (m-1)^{th} first touch wiring 121-m-1.

In the actual manufacturing process, due to the accuracy of the manufacturing process and other reasons, it is difficult to ensure that the spacing between the compensation wiring portion C and the m^{th} second touch wiring 121-m is completely equal to the spacing between the m^{th} first touch wiring 121-m and the (m-1)^{th} first touch wiring 121-m-1, and it is also difficult to ensure that the parallel distance between the compensation wiring portion C and the m^{th} second touch wiring 121-m is completely equal to the parallel distance between the m^{th} first touch wiring 121-m and the (m-1)^{th} first touch wiring 121-m-1. The term “equal” used here refers to the value within the acceptable deviation range determined by those ordinary skilled in the art. For example, the spacing between compensation wiring portion C and m^{th} second touch wiring 121-m is within the range of ±5% of the spacing between the m^{th} first touch wiring 121- m and the (m-1)^{th} first touch wiring 121-m-1, and the parallel distance between compensation wiring portion C and the m^{th} second touch wiring 121-m is within the range of ±5% of the parallel distance between the m^{th} first touch wiring 121-m and the (m-1)^{th} first touch wiring 121-m-1.

In the embodiments of the present disclosure, the spacing between the compensation wiring portion C and the m^{th} first touch wiring 121-m is less than the spacing between the m^{th} first touch wiring 121-m and the (m-1)^{th} first touch wiring 121-m-1, and the parallel distance between the compensation wiring portion C and the m^{th} first touch wiring 121-m is less than the parallel distance between the m^{th} first touch wiring 121-m and the (m-1)^{th} first touch wiring 121-m-1, such that the compensation capacitance generated between the compensation wiring portion C and the m^{th} first touch wiring 121-m is substantially equal to the parasitic capacitance generated between the m^{th} first touch wiring 121-m and the (m-1)^{th} first touch wiring 121-m-1. In this way, the area occupied by the compensation wiring portion C may be reduced.

In the embodiments of the present disclosure, with reference to FIG. 2, the touch structure includes a plurality of touch driving electrodes and a plurality of touch sensing electrodes. The first touch electrode portion 111a in the first touch electrode strip 111 is the touch driving electrode, and the first touch electrode strip 111 is used as the touch driving electrode strip. The second touch electrode portion 112a in the second touch electrode strip 112 is the touch sensing electrode, and the second touch electrode strip 112 is used as the touch sensing electrode strip. That is, the touch wiring electrically connected to the touch driving electrode strip is provided with the above-mentioned compensation wiring portion C.

In the embodiments of the present disclosure, with reference to FIG. 2, the touch structure includes a plurality of touch driving electrodes and a plurality of touch sensing electrodes. The first touch electrode portion 111a in the first touch electrode strip 111 is the touch sensing electrode, and the first touch electrode strip 111 is used as the touch sensing electrode strip. The second touch electrode portion 112a in the second touch electrode strip 112 is the touch driving electrode, and the second touch electrode strip 112 is used as the touch driving electrode strip. That is, the touch wiring electrically connected to the touch driving electrode strip is provided with the above-mentioned compensation wiring portion C.

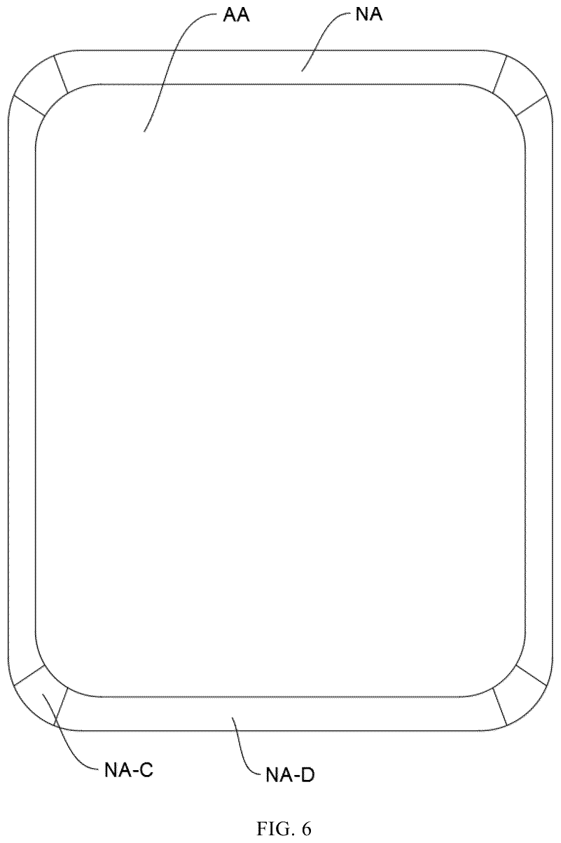

FIG. 5 schematically shows a schematic cross-sectional view of a touch structure according to an embodiment of the present disclosure.

In the embodiments of the present disclosure, with reference to FIG. 5, the touch structure 100 includes a first touch metal layer 100A, a touch insulating layer 100B, and a second touch metal layer 100C. The touch insulating layer 100B is on the first touch metal layer 100A, and the second touch metal layer 100C is on a side of the touch insulating layer 100B away from the first touch metal layer 100A.

With reference to FIG. 2, generally, the first touch electrode portion 111a and the second touch electrode portion 112a are in the second touch metal layer 100C. One of the first connection portion 111b and the second connection portion 112b is in the second touch metal layer 100C, and the other of the first connection portion 111b and the second connection portion 112b is in the first touch metal layer 100A. For example, the first connection portion 111b is in the second touch metal layer 100C, and the second connection portion 112b is in the first touch metal layer 100A. The first connection portion 111b is directly connected to the first touch electrode portion 111a, and the second touch electrode portion 112a is connected to the second connection portion 112b through a via hole in the touch insulating layer 100B.

In some optional implementation methods of the present embodiment, the first touch wiring 121, the second touch wiring 122, and the third touch wiring are in the second touch metal layer 100C.

In some optional implementation methods of the present embodiment, the first touch wiring 121, the second touch wiring 122, and the third touch wiring are in the first touch metal layer 100A.

In some optional implementation methods of the present embodiment, the first touch wiring 121, the second touch wiring 122, and the third touch wiring are in the second touch metal layer 100C and the first touch metal layer 100A. That is, each of the first touch wiring 121, the second touch wiring 122, and the third touch wiring is composed of two layers of conductive wirings in the second touch metal layer 100C and the first touch metal layer 100A, where the two layers of conductive wirings overlap with each other and are electrically connected to each other. Each touch wiring has a structure in which two layers of conductive wirings are in parallel connection, which may reduce signal attenuation on the touch wiring and optimize the touch effect.

In the embodiments of the present disclosure, the compensation wiring portion C is in the same layer as the first touch wiring 121 and the second touch wiring 122. Specifically, when the first touch wiring 121 and the second touch wiring 122 are in the second touch metal layer 100C, the compensation wiring portion C is also in the second touch metal layer 100C. When the first touch wiring 121 and the second touch wiring 122 are in the first touch metal layer 100A, the compensation wiring portion C is also in the first touch metal layer 100A. When the first touch wiring 121 and the second touch wiring 122 are in the second touch metal layer 100C and the first touch metal layer 100A, the compensation wiring portion C is also in the second touch metal layer 100C and the first touch metal layer 100A.

For example, a material of each of the second touch metal layer 100C and the first touch metal layer 100A may include a metal material or an alloy material, and may be a single-layer metal or a multi-layer metal stack. For example, each of the second touch metal layer 100C and the first touch metal layer 100A may be composed of a three-layer metal stack of titanium, aluminum, and titanium (Ti/Al/Ti).

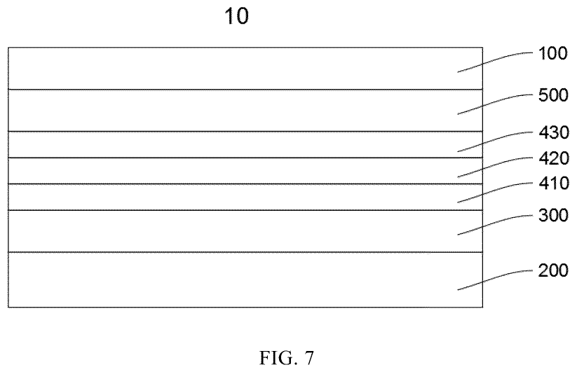

FIG. 6 schematically shows a schematic plan view of a display substrate according to an embodiment of the present disclosure. FIG. 7 schematically shows a schematic cross-sectional view of a display substrate according to an embodiment of the present disclosure.

With reference to FIG. 6, the display substrate includes a display region AA and a peripheral region NA on a periphery of the display region AA. With reference to FIG. 7, the display substrate includes a base substrate 200, a driving layer 300, a first electrode layer 410, a light-emitting layer 420, a second electrode layer 430, an encapsulation layer 500, and the touch structure 100 provided in the above-mentioned embodiments. The driving layer 300 is on the base substrate 200. The first electrode layer 410 is on a side of the driving layer 300 away from the base substrate 200. The light-emitting layer 420 is on a side of the first electrode layer 410 away from the driving layer 300. The second electrode layer 430 is on a side of the light-emitting layer 420 away from the first electrode layer 410. The encapsulation layer 500 is on a side of the second electrode layer 430 away from the light-emitting layer 420. The touch structure 100 is on a side of the encapsulation layer 500 away from the second electrode layer 430.

For example, the first touch electrode strip and the second touch electrode strip in the touch structure 100 are substantially in the display region AA. The first touch wiring, the second touch wiring, and the third touch wiring are substantially in the peripheral region NA.

For example, the base substrate 200 may be a rigid substrate or a flexible substrate. The flexible substrate may be a polyimide (PI) substrate, and the rigid substrate may be a glass substrate. However, the present disclosure is not limited to this.

For example, the first electrode layer 410 includes a plurality of first electrodes spaced apart from each other. The light-emitting layer 420 includes a plurality of light-emitting portions spaced apart from each other. One light-emitting portion is on one first electrode. The entire second electrode layer 430 is provided in the display region AA. One first electrode, one light-emitting portion on the one first electrode, and a part of the second electrode layer 430 on the one light-emitting portion constitute one light-emitting device.

For example, the driving layer 300 includes a plurality of switching elements. One switching element is electrically connected to the first electrode of one light-emitting device, so as to control the light-emitting device to be turned on or off. The switching element 540 may be a thin film transistor.

For example, a material of the first electrode layer 410 may include at least one transparent conductive oxide material, including indium tin oxide (ITO), indium zinc oxide (IZO), zinc oxide (ZnO), and the like. Moreover, the first electrode layer 410 may include a metal with high reflectivity as a reflective layer, such as silver (Ag).

For example, a material of the light-emitting layer 420 may include a small molecule organic material or a polymer molecule organic material, and may be a fluorescent light-emitting material or a phosphorescent light-emitting material, which may emit red light, green light, blue light, or white light.

For example, the second electrode layer 430 may include various conductive materials. For example, the second electrode layer 430 may include a metal material such as lithium (Li), aluminum (Al), magnesium (Mg) and silver (Ag), or an alloy material composed of the aforementioned metal materials.

For example, functional layers such as a hole injection layer and a hole transport layer may be further provided between the first electrode layer 410 and the light-emitting layer 420. Functional layers such as an electron injection layer and an electron transport layer may be further provided between the second electrode layer 430 and the light-emitting layer 420.

For example, the encapsulation layer 500 covers and seals each light-emitting device, thereby reducing or preventing degradation of the light-emitting devices caused by moisture or oxygen included in the environment. The encapsulation layer 500 may be a single-layer structure or a composite-layer structure. The composite-layer structure includes a stack of an inorganic layer and an organic layer.

For example, the encapsulation layer 500 includes a first inorganic encapsulation layer, an organic encapsulation layer, and a second inorganic encapsulation layer stacked sequentially.

For example, a material of each of the first inorganic encapsulation layer and the second inorganic encapsulation layer may include an insulating material such as silicon nitride, silicon oxide, and silicon oxynitride. Inorganic materials such as silicon nitride, silicon oxide, and silicon oxynitride have high compactness and may prevent the invasion of water and oxygen, etc. A material of the organic encapsulation layer may be a polymer material containing a desiccant or a polymer material that may block water vapor, such as a polymer resin, so as to planarize the surface of the display substrate and relieve a stress of the first inorganic encapsulation layer and the second inorganic encapsulation layer. The material of the organic encapsulation layer may further include a water absorbing material, such as a desiccant, to absorb substances such as water and oxygen that invade the interior.

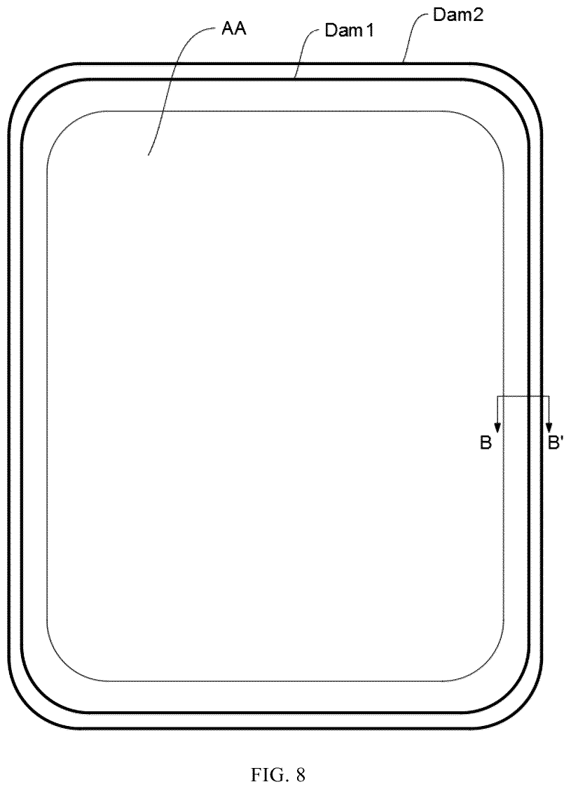

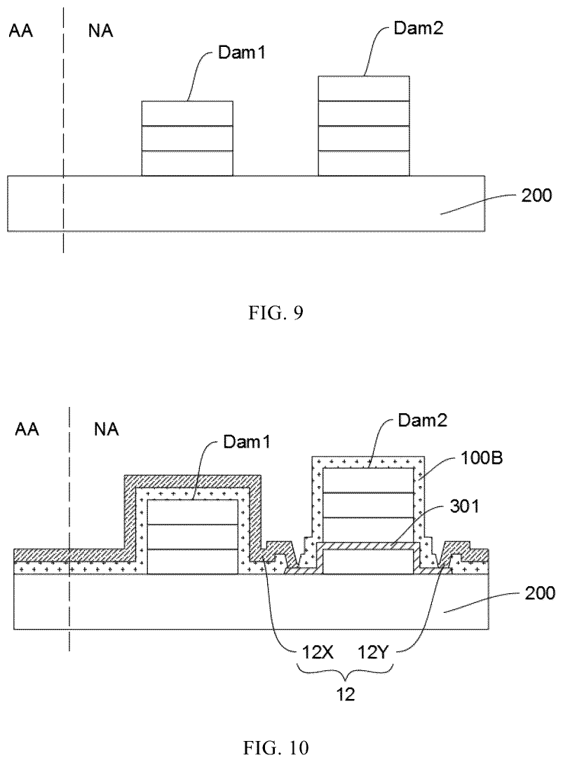

FIG. 8 schematically shows a schematic plan view of a dam in a display substrate according to an embodiment of the present disclosure. FIG. 9 schematically shows a schematic cross-sectional view at position B-B′ in FIG. 8.

With reference to FIG. 8 and FIG. 9, the display substrate includes a dam on the base substrate 200 and in the peripheral region. The dam includes a first dam Dam1 surrounding the display region and a second dam Dam2 surrounding the first dam Dam1. At least one of the touch wirings extends from a side of the second dam Dam2 close to the display region AA to a side of the second dam Dam2 away from the display region AA.

A height of the second dam Dam2 is higher than a height of the first dam Dam1. Generally, the first dam Dam1 includes a plurality of first dam portions stacked, and the second dam Dam2 includes a plurality of second dam portions stacked. For example, the first dam Dam1 includes three first dam portions stacked, and the second dam Dam2 includes four second dam portions stacked.

For example, the display substrate includes a first planarization layer on the base substrate, a second planarization layer on a side of the first planarization layer away from the base substrate, a third planarization layer on a side of the second planarization layer away from the base substrate, a fourth planarization layer on a side of the third planarization layer away from the base substrate, and an isolation column layer on a side of the fourth planarization layer away from the base substrate. The three first dam portions are respectively in any three of the first planarization layer, the second planarization layer, the third planarization layer, the fourth planarization layer, and the isolation column layer. The four second dam portions are respectively in any four of the first planarization layer, the second planarization layer, the third planarization layer, the fourth planarization layer, and the isolation column layer.

For example, the three first dam portions are respectively in the third planarization layer, the fourth planarization layer, and the isolation column layer. The four second dam portions are respectively in the second planarization layer, the third planarization layer, the fourth planarization layer, and the isolation column layer.

Since the height of the second dam Dam2 is high, a significant height difference is formed between the second dam Dam2 and the base substrate 200. When the touch wirings cross the second dam Dam2, there is a risk of breakage in the part of the touch wirings at the edge of the upper surface of the second dam Dam2, which may cause the interruption of touch signal transmission and affect the touch sensitivity.

FIG. 10 schematically shows another schematic cross-sectional view at position B-B′ in FIG. 8.

In order to improve the above-mentioned problem, the display substrate further includes a bridging wiring portion. The bridging wiring portion is on a side of the second dam close to the base substrate or on a side of a part of the second dam close to the base substrate. With reference to FIG. 10, the display substrate further includes a bridging wiring portion 301 on a side of a part of the second dam Dam2 close to the base substrate 200. For example, the second dam Dam2 includes four second dam portions stacked, and the bridging wiring portion 301 is between three second dam portions away from the base substrate 200 and one second dam portion close to the base substrate 200.

At least one of the touch wirings 12 includes an inner touch wiring portion 12X on a side of the second dam Dam2 close to the display region AA and an outer touch wiring portion 12Y on a side of the second dam Dam2 away from the display region AA. One end of the bridging wiring portion 301 is electrically connected to the inner touch wiring portion 12X, and the other end of the bridging wiring portion 301 is electrically connected to the outer touch wiring portion 12Y. That is, the touch wiring 12 is disconnected at the second dam Dam2, and the disconnected parts of the touch wiring 12 are connected through the bridging wiring portion 301 on the lower side of the second dam Dam2. Therefore, the touch wiring 12 does not need to cross the upper surface of the second dam Dam2, thereby avoiding the problem of breakage of the touch wiring 12 at the second dam Dam2.

For example, the touch wiring 12 is in the second touch metal layer. A touch insulating layer 100B is provided on a side of the touch wiring 12 close to the base substrate. Each of the inner touch wiring portion 12X and the outer touch wiring portion 12Y is lapped joint with the bridging wiring portion 301 through the via hole in the touch insulating layer 100B, so as to achieve the electrical connection of the inner touch wiring portion 12X and the outer touch wiring portion 12Y.

According to some exemplary embodiments, the display substrate further includes: a source drain metal layer on the base substrate 200, and a touch metal layer on a side of the source drain metal layer away from the base substrate 200. The bridging wiring portion 301 is in the source drain metal layer. The inner touch wiring portion and the outer touch wiring portion are in the touch metal layer.

It should be noted that the touch metal layer here is the first touch metal layer and/or the second touch metal layer in the aforementioned embodiment, which will not be repeated in this embodiment.

For example, the driving layer 300 includes a first source drain metal layer on the base substrate 200, a second source drain metal layer on a side of the first source drain metal layer away from the base substrate, and a third source drain metal layer on a side of the second source drain metal layer away from the base substrate. The source drain metal layer may be any one of the first source drain metal layer, the second source drain metal layer, and the third source drain metal layer.

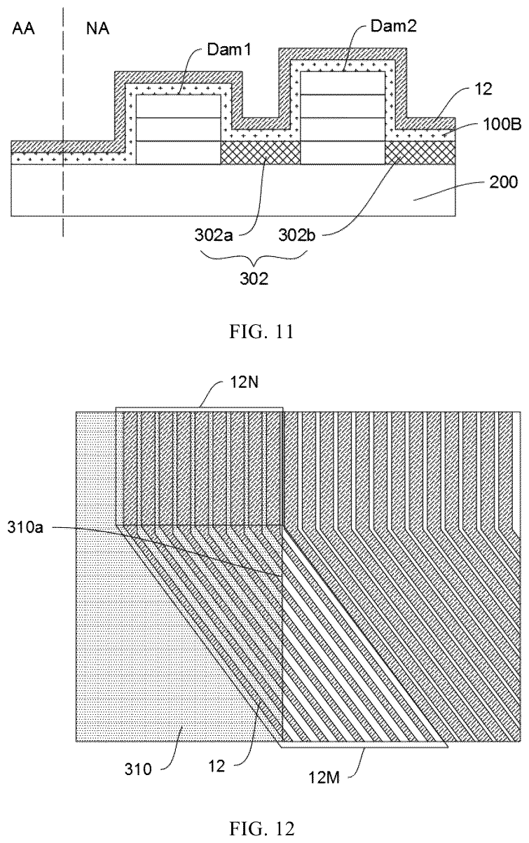

FIG. 11 schematically shows another schematic cross-sectional view at position B-B′ in FIG. 8.

With reference to FIG. 11, the display substrate further includes a raised portion 302 adjacent to the second dam Dam2. The raised portion 302 includes a first raised portion 302a on a side of the second dam Dam2 close to the display region AA and a second raised portion 302b on a side of the second dam Dam2 away from the first raised portion 302a. At least one of the touch wirings 12 crosses the second dam Dam2 via the first raised portion 302a and extends to the second raised portion 302b. By providing the raised portion 302 on both sides of the second dam Dam2, the touch wiring 12 does not directly cross a step structure formed by the second dam Dam2 and the base substrate 200, but rather crosses a step structure formed by the raised portion 302 and the base substrate 200 and a step structure formed by the second dam Dam2 and the raised portion 302. Through the buffering of the raised portion 302, the risk of breakage in the part of the touch wirings 12 at the edge of the upper surface of the second dam Dam2 is greatly reduced.

According to some exemplary embodiments, the first raised portion 302a is directly connected to the first dam Dam1 on a side of the first raised portion 302a away from the second dam Dam2.

According to some exemplary embodiments, the touch wiring 12 is in the touch metal layer. The display substrate further includes a planarization layer on a side of the touch metal layer close to the base substrate, and the raised portion 302 is in the planarization layer.

For example, the display substrate includes a second planarization layer on the base substrate, a third planarization layer on a side of the second planarization layer away from the base substrate, a fourth planarization layer on a side of the third planarization layer away from the base substrate, and an isolation column layer on a side of the fourth planarization layer away from the third planarization layer. The planarization layer may be any one of the second planarization layer, the third planarization layer, the fourth planarization layer, and the isolation column layer.

The inventors also find that at the boundary of the organic insulating layer in the display substrate, there may be a problem of touch wiring short circuiting between adjacent two touch wirings due to etching residue. Based on this problem, the inventors have made effective improvements through research.

FIG. 12 schematically shows a schematic plan view of a touch wiring at a boundary of an organic insulating layer in a display substrate according to an embodiment of the present disclosure.

With reference to FIG. 12, the display substrate includes: an organic insulating layer 310 on a side of the plurality of touch wirings close to the base substrate 200. The plurality of touch wirings 12 include a first wiring portion 12M crossing a boundary 310a of the organic insulating layer 310 and a second wiring portion 12N on both sides of the first wiring portion 12M. FIG. 12 schematically shows one second wiring portion 12N on one side of the first wiring portion 12M. It should be understood that in the extension direction of each touch wiring 12 in the second wiring portion 12N, another second wiring portion 12N is further provided on a side of the first wiring portion 12M away from the illustrated second wiring portion 12N.

A spacing between adjacent two touch wirings 12 in the first wiring portion 12M is a first spacing. A spacing between adjacent two touch wirings 12 in the second wiring portion 12N is a second spacing. The first spacing is greater than the second spacing. Through verification, the problem of etching residue in the first wiring portion 12M may be effectively improved by increasing the spacing between the touch wirings in the first wiring portion 12M, thereby avoiding the problem of adjacent touch wirings being short circuited in the first wiring portion 12M.

It should be noted that in order to achieve that the first spacing is greater than the second spacing, a line width of the touch wiring 12 in the first wiring portion 12M is set to be less than the line width of the touch wiring 12 in the second wiring portion 12N.

According to some exemplary embodiments, the first spacing is greater than or equal to 8 microns. For example, the first spacing is 8 microns, 8.5 microns, 9 microns, 9.5 microns, 10 microns, 11 microns, 12 microns, 13 microns, 14 microns, or 15 microns, etc. In theory, the thicker the crossed organic insulating layer 310 and/or the steeper the cone angle formed between an edge sidewall of the organic insulating layer 310 and a bottom surface of the organic insulating layer 310, the greater the first spacing.

According to some exemplary embodiments, the display substrate includes: a first planarization layer on the base substrate 200; a second planarization layer on a side of the first planarization layer away from the base substrate 200; and a third planarization layer on a side of the second planarization layer away from the base substrate 200. The organic insulating layer includes at least one of the first planarization layer, the second planarization layer, and the third planarization layer.

In the display substrate, there is a touch signal in the touch structure 100, which is transmitted by the touch wirings. There is a back panel (BP) signal in the driving layer 300, such as a data signal and a gate drive (GOA) signal, for driving the display substrate to display. In order to avoid mutual interference between the touch signal and the back panel signal, a signal shielding structure is usually required between the touch wirings and the back panel signal wirings in the driving layer 300.

According to some exemplary embodiments, with reference to FIG. 6 and FIG. 7, the display substrate includes a first electrode layer 410 on a side of the light-emitting layer 420 close to the base substrate 200, and the peripheral region NA includes a corner region NA-C outside the corner of the display region AA.

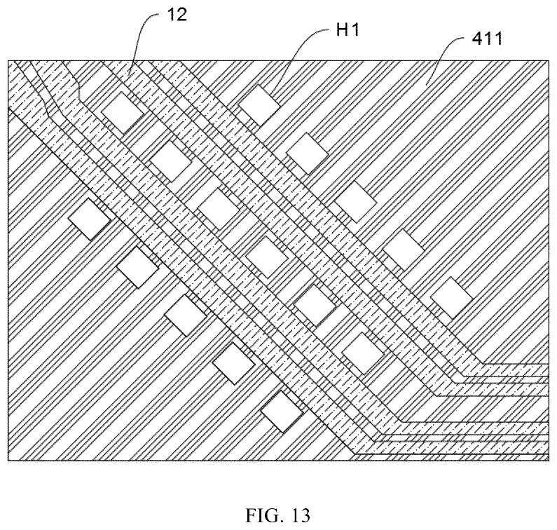

FIG. 13 schematically shows a schematic plan view of a touch wiring in a corner region of a display substrate according to an embodiment of the present disclosure.

With reference to FIG. 13, the display substrate includes: a second electrode power signal bridging portion 411 in the first electrode layer 410. The second electrode power signal bridging portion 411 includes a first exhaust hole H1. The second electrode power signal bridging portion 411 is between the touch structure 100 and the driving layer 300, and may be used as the above-mentioned signal shielding structure.

A part of the second electrode power signal bridging portion 411 is in the corner region NA-C, and a part of the touch wirings 12 is in the corner region NA-C. Since the second electrode power signal bridging portion 411 is provided with the first exhaust hole H1, in the first exhaust hole H1 region, no structure that may achieve shielding is between the touch wirings and the back panel signal wirings in the driving layer 300. Therefore, in the corner region NA-C, the orthographic projection of the touch wiring 12 on the base substrate 200 does not overlap with the orthographic projection of the first exhaust hole H1 on the base substrate 200. For example, the orthographic projection of the touch wiring 12 on the base substrate 200 is spaced apart from the orthographic projection of the first exhaust hole H1 on the base substrate 200, or a partial edge of the orthographic projection of the touch wiring 12 on the base substrate 200 is flush with a partial edge of the orthographic projection of the first exhaust hole H1 on the base substrate 200. That is, in the corner region NA-C, the touch wiring 12 is avoided from the first exhaust hole H1.

It should be noted that one or more planarization layers are usually on a side of the first electrode layer 410 close to the base substrate. The planarization layer PLN is usually made of organic resin materials. There are organic substances that are easily volatile when exposed to heat, such as organic solvents or small molecule materials, in the planarization layer. These organic substances are prone to volatilization when exposed to heat during the subsequent manufacturing process of the display panel, leading to the outgassing phenomenon in the planarization layer. By providing the first exhaust hole H1 in the first electrode layer 410, it is beneficial for the organic substances in the planarization layer to volatilize when exposed to heat during the subsequent manufacturing process of the display substrate, thereby avoiding the accumulation of bubbles on the surface of the first electrode layer 410 facing the planarization layer. In this way, it is beneficial to ensure the process yield of the display substrate, thereby ensuring the good display effect of the display substrate.

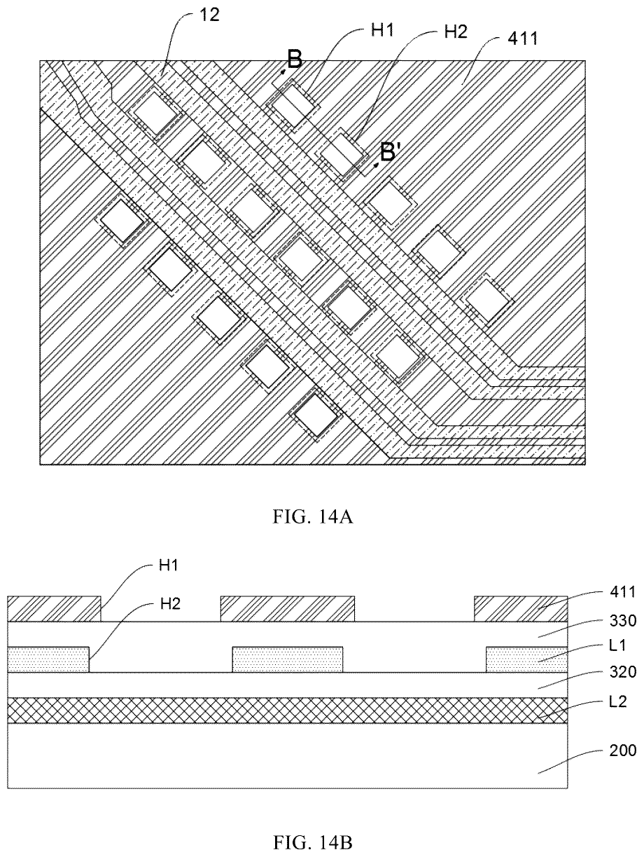

FIG. 14A schematically shows a schematic plan view of a touch wiring in a corner region of a display substrate according to an embodiment of the present disclosure. FIG. 14B schematically shows a schematic cross-sectional view at position BB′ in FIG. 14A.

With reference to FIG. 7, FIG. 14A, and FIG. 14B, the display substrate further includes a source drain metal layer on a side of the first electrode layer 410 close to the base substrate 200. The display substrate further includes a second electrode signal wiring L1 in the source drain metal layer. The second electrode signal wiring L1 is usually on a side of the back panel signal wiring L2 in the driving layer 300 close to the touch wiring, and thus the second electrode signal wiring L1 may also be used as the above-mentioned signal shielding structure. A first insulating layer 320 is provided between the second electrode signal wiring L1 and the back panel signal wiring L2, and a second insulating layer 330 is provided between the second electrode signal wiring L1 and the second electrode power signal bridging portion 411.

A part of the second electrode signal wiring L1 is in the corner region NA-C, and the second electrode signal wiring L1 includes a second exhaust hole H2. In the corner region NA-C, the orthographic projection of the first exhaust hole H1 on the base substrate 200 at least partially overlaps with an orthographic projection of the second exhaust hole H2 on the base substrate 200. However, in the overlapping region of the first exhaust hole H1 and the second exhaust hole H2, no structure that may achieve shielding is between the touch wiring and the back panel signal wiring L2 in the driving layer 300.

Therefore, in the corner region NA-C, the orthographic projection of the touch wiring 12 on the base substrate 200 is spaced apart from the orthographic projection of any one of the first exhaust hole H1 and the second exhaust hole H2 on the base substrate 200. That is, in the corner region NA-C, the touch wiring 12 is avoided from the first exhaust hole H1 and the second exhaust hole H2.

The purpose of providing the second exhaust hole H2 is similar to that of the first exhaust hole H1, which will not be repeated here.

The second electrode power signal bridging portion 411 is electrically connected to the second electrode signal wiring and the second electrode layer 430, respectively. The second electrode power signal bridging portion 411 is used to transmit the second electrode signal received from the second electrode signal wiring L1 to the second electrode layer 430.

It should be noted that in the corner region NA-C, the purpose of at least partially overlapping the first exhaust hole H1 with the second exhaust hole H2 is to improve the yield of the adhesive coating process in the corner region NA-C.

According to some exemplary embodiments, the display substrate further includes: a source drain metal layer on a side of the first electrode layer 410 close to the base substrate 200, and a second electrode signal wiring in the source drain metal layer. The orthographic projection of the second electrode signal wiring on the base substrate 200 is spaced apart from the orthographic projection of the first exhaust hole H1 in the corner region NA-C on the base substrate 200.

For example, with reference to FIG. 13, the second electrode signal wiring is outside the corner region NA-C. Obviously, the orthographic projection of the second electrode signal wiring on the base substrate 200 is spaced apart from the orthographic projection of the first exhaust hole H1 in the corner region NA-C on the base substrate 200.

For example, a part of the second electrode signal wiring is in the corner region NA-C. However, an orthographic projection of the part of the second electrode signal wiring in the corner region NA-C on the base substrate 200 is spaced apart from the orthographic projection of the first exhaust hole H1 in the corner region NA-C on the base substrate 200.

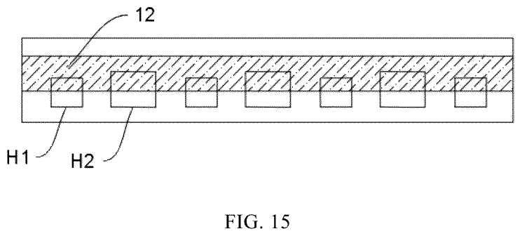

FIG. 15 schematically shows a schematic plan view of a touch wiring in a first side region of a display substrate according to an embodiment of the present disclosure.

With reference to FIG. 15 and FIG. 6, the peripheral region NA further includes a first side region NA-D on a side of the display region AA in the second direction Y. In the first side region NA-D, the orthographic projection of the first exhaust hole H1 on the base substrate 200 is spaced apart from the orthographic projection of the second exhaust hole H2 on the base substrate 200.

In the first side region NA-D, the first exhaust hole H1 is spaced apart from the second exhaust hole H2, that is, the first exhaust hole H1 does not overlap with the second exhaust hole H2. Therefore, the second electrode signal wiring L2 may be used as the above-mentioned signal shielding structure in the region where the first exhaust hole H1 is provided, and the second electrode power signal bridging portion 411 may be used as the above-mentioned signal shielding structure in the region where the second exhaust hole H2 is provided.

Therefore, in the first side region NA-D, the touch wiring 12 does not need to avoid the first exhaust hole H1 and/or the second exhaust hole H2. That is, the orthographic projection of the touch wiring 12 on the base substrate 200 at least partially overlaps with the orthographic projection of the first exhaust hole H1 on the base substrate 200; and/or, the orthographic projection of the touch wiring 12 on the base substrate 200 at least partially overlaps with the orthographic projection of the second exhaust hole H2 on the base substrate 200.

It should be noted that, the adhesive coating process has a high yield in the first side region NA-D. Therefore, there is no need to at least partially overlap the first exhaust hole H1 with the second exhaust hole H2.

On another aspect, a display device is provided, including the above-mentioned display substrate. The display device may be a display device such as a liquid crystal display, an electronic paper, and a OLED (Organic Light-Emitting Diode) display, and any product or component with touch and display functions and including the above display devices, such as a television, a digital camera, a mobile phone, a watch, a tablet, a laptop, a navigator, and the like.

It should be understood that the display device according to some exemplary embodiments of the present disclosure has all the characteristics and advantages of the display substrate described above, and the characteristics and advantages may be referred to the above description for the display substrate, which will not be repeated here.

As used herein, the terms “substantially”, “about”, “approximately”, and other similar terms are used as terms of approximation rather than as terms of degree, and are intended to account for inherent deviations in measured or calculated values that would be recognized by those of ordinary skill in the art. Taking into account factors such as process fluctuations, measurement problems, errors associated with measurement of particular quantities (i.e., limitations of a measurement system), etc., “about” or “approximately” as used in the present disclosure includes the stated values, and indicates that the particular values determined by those of ordinary skill in the art are within acceptable tolerances. For example, “about” may mean within one or more standard deviations, or within ±10% or ±5% of the stated values.

Some embodiments of the general concept of the present disclosure have been illustrated and described. However, those skilled in the art will understand that these embodiments may be changed without departing from the principle and spirit of the general concept of the present disclosure. The scope of the present disclosure is defined by the claims and their equivalents.

1. A touch structure, comprising: a first touch region, a second touch region, a first touch wiring region, and a second touch wiring region, wherein the second touch region is on a side of the first touch region in a first direction, the second touch wiring region is on a side of the first touch wiring region in the first direction, and the touch structure further comprises:
a plurality of first touch electrode strips extending in a second direction and spaced apart from each other in the first direction, wherein one or more of the plurality of first touch electrode strips are in the first touch region, rest of the plurality of first touch electrode strips are in the second touch region, and the first direction intersects with the second direction; and
a plurality of touch wirings, comprising a first touch wiring group in the first touch wiring region and a second touch wiring group in the second touch wiring region, wherein the first touch wiring group comprises m first touch wirings, the first touch wiring is electrically connected to the first touch electrode strip in the first touch region, and adjacent two first touch wirings are in parallel; the second touch wiring group comprises n second touch wirings, the second touch wiring is electrically connected to the first touch electrode strip in the second touch region, adjacent two second touch wirings are in parallel; and each of m and n is an integer greater than or equal to 2,
wherein the first touch wiring group comprises a m^{th} first touch wiring closest to the second touch wiring group, the second touch wiring group comprises a n^{th} second touch wiring closest to the first touch wiring group, and one of the m^{th} first touch wiring and the n^{th} second touch wiring comprises a compensation wiring portion, such that a part of the m^{th} first touch wiring is parallel to the compensation wiring portion in the n^{th} second touch wiring or a part of the n^{th} second touch wiring is parallel to the compensation wiring portion in the m^{th} first touch wiring, so as to generate a compensation capacitance between the m^{th} first touch wiring and the n^{th} second touch wiring.

2. The touch structure according to claim 1, wherein the m^{th} first touch wiring comprises the compensation wiring portion, the compensation wiring portion extends from the first touch wiring region to the second touch wiring region, the compensation wiring portion is parallel to the part of the n^{th} second touch wiring, the second touch wiring group comprises a (n-1)^{th} second touch wiring adjacent to the n^{th} second touch wiring, and the compensation wiring portion is on a side of the n^{th} second touch wiring away from the (n-1)^{th} second touch wiring; or
wherein the n^{th} second touch wiring comprises the compensation wiring portion, the compensation wiring portion extends from the second touch wiring region to the first touch wiring region, the compensation wiring portion is parallel to the part of the m^{th} first touch wiring, the first touch wiring group comprises a (m-1)^{th} first touch wiring adjacent to the m^{th} first touch wiring, and the compensation wiring portion is on a side of the m^{th} first touch wiring away from the (m-1)^{th} first touch wiring.

3. The touch structure according to claim 2, wherein a compensation capacitance generated between the compensation wiring portion and the n^{th} second touch wiring is substantially equal to a parasitic capacitance generated between the n^{th} second touch wiring and the (n-1)^{th} second touch wiring; or
wherein a compensation capacitance generated between the compensation wiring portion and the m^{th} first touch wiring is substantially equal to a parasitic capacitance generated between the m^{th} first touch wiring and the (m-1)^{th} first touch wiring.

4. The touch structure according to claim 2, wherein a spacing between the compensation wiring portion and the n^{th} second touch wiring is equal to a spacing between the n^{th} second touch wiring and the (n-1)^{th} second touch wiring, and a parallel distance between the compensation wiring portion and the n^{th} second touch wiring is equal to a parallel distance between the n^{th} second touch wiring and the (n-1)^{th} second touch wiring; or
wherein a spacing between the compensation wiring portion and the m^{th} first touch wiring is equal to a spacing between the m^{th} first touch wiring and the (m-1)^{th} first touch wiring, and a parallel distance between the compensation wiring portion and the m^{th} first touch wiring is equal to a parallel distance between the m^{th} first touch wiring and the (m-1)^{th} first touch wiring.

5. The touch structure according to claim 2, wherein a spacing between the compensation wiring portion and the n^{th} second touch wiring is less than a spacing between the n^{th} second touch wiring and the (n-1)^{th} second touch wiring, and a parallel distance between the compensation wiring portion and the n^{th} second touch wiring is less than a parallel distance between the n^{th} second touch wiring and the (n-1)^{th} second touch wiring; or
wherein a spacing between the compensation wiring portion and the m^{th} first touch wiring is less than a spacing between the m^{th} first touch wiring and the (m-1)^{th} first touch wiring, and a parallel distance between the compensation wiring portion and the m^{th} first touch wiring is less than a parallel distance between the m^{th} first touch wiring and the (m-1)^{th} first touch wiring.

6. The touch structure according to claim 1, wherein the touch structure further comprises a plurality of touch driving electrodes and a plurality of touch sensing electrodes, and
wherein one first touch electrode strip comprises the plurality of touch driving electrodes arranged sequentially in the second direction and electrically connected to each other, or one first touch electrode strip comprises the plurality of touch sensing electrodes arranged sequentially in the second direction and electrically connected to each other.

7. The touch structure according to claim 1, wherein the compensation wiring portion is in a same layer as the first touch wiring group and the second touch wiring group.

8. A display substrate, wherein the display substrate comprises a display region and a peripheral region at a periphery of the display region, and the display substrate further comprises:
a base substrate;
a light-emitting layer on the base substrate;
an encapsulation layer on a side of the light-emitting layer away from the base substrate; and
a touch structure on a side of the encapsulation layer away from the base substrate, wherein the touch structure comprises the touch structure according to claim 1.

9. The display substrate according to claim 8, further comprising:
a dam on the base substrate and in the peripheral region,
wherein the dam comprises a first dam surrounding the display region and a second dam surrounding the first dam, and at least one of the touch wirings extends from a side of the second dam close to the display region to a side of the second dam away from the display region.

10. The display substrate according to claim 9, further comprising:
a bridging wiring portion on a side of the second dam close to the base substrate or on a side of a part of the second dam close to the base substrate,
wherein at least one of the touch wirings comprises an inner touch wiring portion on the side of the second dam close to the display region and an outer touch wiring portion on the side of the second dam away from the display region, one end of the bridging wiring portion is electrically connected to the inner touch wiring portion, and the other end of the bridging wiring portion is electrically connected to the outer touch wiring portion.

11. The display substrate according to claim 10, further comprising:
a source drain metal layer on the base substrate; and
a touch metal layer on a side of the source drain metal layer away from the base substrate,
wherein the bridging wiring portion is in the source drain metal layer, and the inner touch wiring portion and the outer touch wiring portion are in the touch metal layer.

12. The display substrate according to claim 9, further comprising:
a raised portion adjacent to the second dam,
wherein the raised portion comprises a first raised portion on the side of the second dam close to the display region and a second raised portion on a side of the second dam away from the first raised portion, and at least one of the touch wirings crosses the second dam via the first raised portion and extends to the second raised portion.

13. The display substrate according to claim 12, wherein the touch wiring is in a touch metal layer, the display substrate further comprises a planarization layer on a side of the touch metal layer close to the base substrate, and the raised portion is in the planarization layer.

14. The display substrate according to claim 8, further comprising:
an organic insulating layer on a side of the plurality of touch wirings close to the base substrate,
wherein the plurality of touch wirings further comprise a first wiring portion crossing a boundary of the organic insulating layer and a second wiring portion on both sides of the first wiring portion, a spacing between adjacent two touch wirings in the first wiring portion is a first spacing, a spacing between adjacent two touch wirings in the second wiring portion is a second spacing, and the first spacing is greater than the second spacing, and
wherein the first spacing is greater than or equal to 8 microns.

15. (canceled)

16. The display substrate according to claim 14, further comprising:
a first planarization layer on the base substrate;
a second planarization layer on a side of the first planarization layer away from the base substrate; and
a third planarization layer on a side of the second planarization layer away from the base substrate;
wherein the organic insulating layer comprises at least one of the first planarization layer, the second planarization layer, and the third planarization layer.

17. The display substrate according to claim 8, wherein the display substrate further comprises a first electrode layer on a side of the light-emitting layer close to the base substrate, the peripheral region comprises a corner region outside a corner of the display region, the display substrate further comprises a second electrode power signal bridging portion in the first electrode layer, and the second electrode power signal bridging portion comprises a first exhaust hole;
wherein a part of the second electrode power signal bridging portion is in the corner region, and a part of the touch wiring is in the corner region; and
wherein in the corner region, an orthographic projection of the touch wiring on the base substrate does not overlap with an orthographic projection of the first exhaust hole on the base substrate.

18. The display substrate according to claim 17, further comprising:
a source drain metal layer on a side of the first electrode layer close to the base substrate, and
a second electrode signal wiring in the source drain metal layer;
wherein a part of the second electrode signal wiring is in the corner region, and the second electrode signal wiring comprises a second exhaust hole;
wherein in the corner region, the orthographic projection of the first exhaust hole on the base substrate at least partially overlaps with an orthographic projection of the second exhaust hole on the base substrate, and
wherein in the corner region, the orthographic projection of the touch wiring on the base substrate is spaced apart from the orthographic projection of one of the first exhaust hole and the second exhaust hole on the base substrate.

19. The display substrate according to claim 17, further comprising:
a source drain metal layer on a side of the first electrode layer close to the base substrate, and
a second electrode signal wiring in the source drain metal layer;
wherein an orthographic projection of the second electrode signal wiring on the base substrate is spaced apart from the orthographic projection of the first exhaust hole in the corner region on the base substrate.

20. The display substrate according to claim 18, wherein the peripheral region further comprises a first side region on a side of the display region in the second direction;
wherein in the first side region, the orthographic projection of the first exhaust hole on the base substrate is spaced apart from the orthographic projection of the second exhaust hole on the base substrate; and
wherein in the first side region, the orthographic projection of the touch wiring on the base substrate at least partially overlaps with the orthographic projection of the first exhaust hole on the base substrate; and/or, the orthographic projection of the touch wiring on the base substrate at least partially overlaps with the orthographic projection of the second exhaust hole on the base substrate.

21. A display device, comprising the display substrate according to claim 8
